(19) United States
(12) Patent Application Publication
(10) Pub. No.: US 2002/0049645 A1
(43) Pub. Date: Apr. 25, 2002

(54) Method, system and program for determining selling price, and computer-readable storage medium for storing the program

(75) Inventor: Nobuo Takahashi, Tokyo (JP)

Correspondence Address: SUGHRUE, MION, ZINN, MACPEAK & SEAS, 2100 Pennsylvania Avenue, N.W., Washington, DC, 20037-3202, US

(73) Assignee: NEC CORPORATION

(21) Appl. No.: 09/977,387

(22) Filed: Oct. 16, 2001

(30) Foreign Application Priority Data
Oct. 20, 2000 (JP) 2000-320673

(51) Int. Cl. G06F 17/60

(52) U.S. Cl. 705/26

(57) ABSTRACT

The present invention determines a selling price appropriate for both a purchaser and a supplier in a system of cooperative buying by a plurality of intending purchasers on a network.

When an intending purchaser specifies a desired product by manipulating a buyer terminal 10, an order-receiving center terminal 20 sends a menu including base prices of the product for respective delivery dates to the buyer terminal 10. Referring to this menu, the intending purchaser determines and sends a delivery date as well as an order quantity to the order-receiving center terminal 20. The order-receiving center terminal 20 obtains the so-far accepted total order quantity of the product for the delivery date counting the order quantity sent from the above buyer terminal to estimate a price based on this so-far accepted total order quantity, a period from the present time point to the delivery date and a standard selling price of the product. When the intending purchaser is satisfied with the estimated price, (s)he confirms the order. The final selling price for this order is determined based on the standard selling price, the period from the time of order to the delivery date and the total order quantity for the same delivery date that has been accepted by the time order acceptance is closed.

### FIELD OF THE INVENTION

The present invention relates to a technique of cooperative buying by a plurality of purchasers on a network such as the Internet. More particularly, the present invention relates to a technique for determining a selling price that is appropriate for both purchasers and suppliers based on an order quantity and a period from the time of order acceptance to a delivery date.

### BACKGROUND OF THE INVENTION

A network system for a plurality of intending purchasers to do cooperative buying on a network such as the Internet has been proposed to date. Costs of perishable foods, some industrial products, industrial parts and the like significantly fluctuate depending on an order quantity and a period from the time of order to a delivery date. The above-mentioned network system is useful in purchasing such products at a lower price than the case of an individual purchase.

A network system of a conventional type is established by connecting a plurality of buyer terminals, a plurality of product supplier terminals and an order-receiving center terminal via a network.

The product supplier terminal sends product information including the price, specification and the like of a product provided by the product supplier, and schedule information to the order-receiving center terminal. The order-receiving center terminal controls such product information and schedule information sent from the plurality of product supplier terminals. The prices of the products are determined by the respective product suppliers based on an estimation of the total order quantity (total quantity made by cooperative buying).

The buyer terminal, as operated by a buyer, requests product information to the order-receiving center terminal. Upon receiving the request from the buyer terminal, the order-receiving center terminal sends the product information and schedule information under control to the buyer terminal that has made the request. The product information and the schedule information sent from the order-receiving terminal are displayed on the display screen of the buyer terminal, based on which the intending purchaser selects a product and determines a delivery date and sends order information including the order quantity, the delivery date and the like to the order-receiving center terminal. The selling price is fixed to the price included in the product information. Upon receiving the order information for the product, the order-receiving center terminal sends the order information to the product supplier terminal providing that product.

According to the above-described conventional technique, the product suppliers have to estimate the total order quantity to determine the prices of the products. Therefore, if the estimation goes wrong, either the product supplier or the purchaser may suffer a loss. Specifically, the supplier will suffer a loss if the total order quantity is smaller than expected while the purchaser will suffer a loss if the total order quantity is larger than expected.

The present invention can avoid such a risk and has an objective of determining an appropriate selling price that is profitable for both the buyers and the product suppliers based on an actual order quantity and a period from the time of order acceptance to the delivery date.

### SUMMARY OF THE INVENTION

According to a method for determining a selling price of the invention, a selling price of a product for intending purchasers who have ordered the same product for the same delivery date is determined based on the standard selling price determined by the product supplier, a period from the order acceptance to the delivery date and the total order quantity of the product for that delivery date, so that the selling price is almost the same as the standard selling price if the total order quantity is small and is significantly less expensive than the standard selling price if the total order quantity is large. Accordingly, the selling price can be determined based on the actual state of order. As a result, unlike the conventional technique where the selling prices are determined by estimating the total order quantities, the risk of either the purchaser or the supplier suffering a loss when the estimation goes wrong can be avoided. Since the price becomes less expensive for an earlier order, the orders are likely to be placed earlier, and thus the supplier can confirm the production quantity at an early stage.

According to the method for determining the selling price of the present invention, a delivery-date-basis base price menu of a product is sent from the order-receiving center terminal to a buyer terminal of an intending purchaser interested in that product. The delivery-date-basis base price menu includes a plurality of base prices for respective delivery dates set for the product. The base price of each delivery date is determined based on the period from the present time point to the delivery date and the so-far accepted total order quantity for that delivery date. Thus, the intending purchaser can refer to the delivery-date-basis base price menu to select a delivery date with a lower price (i.e., delivery date with a large order quantity) while the supplier can expect mass order quantity.

According to the method for determining the selling price of the invention, when the order-receiving center terminal receives an estimation request for a particular product, a particular order quantity and a particular delivery date from a purchaser terminal, it estimates a selling price based on the standard selling price of the product, the so-far accepted total order quantity for the desired delivery date including the quantity made by this order and a period from the present time point to the delivery date, and sends the results to the buyer terminal. Since the order quantity placed by the intending purchaser is counted upon this estimation, a price closer to the final selling price can be presented to the intending purchaser.

### BRIEF DESCRIPTION OF THE DRAWINGS

FIG. 1 is a block diagram showing an example of the present invention;

FIG. 2 is a diagram showing an exemplary price scheme;

FIG. 3 is a diagram showing an example of a configuration of the memory device 28;

FIG. 4 is a diagram showing an exemplary data of an order information memory 285;

FIG. 5 is a flowchart showing an exemplary process of operations according to the example;

FIG. 6 is an image showing an example of a delivery-data-basis base price menu;

FIG. 7 is an image showing an initial state of the delivery-data-basis base price menu;

FIG. 8 is an image showing a state where the purchaser has input an order quantity into the delivery-data-basis base price menu shown in FIG. 7;

FIG. 9 is an image showing the delivery-data-basis base price menu after the order has been placed as shown in FIG. 8;

FIG. 10 is a flowchart showing an example of the operation by a final price determining means 25;

FIG. 11 is diagrams showing states of price fluctuating according to timing and quantity of order; and

FIG. 12 is an image showing that the reset prices can be confirmed on the screen.

### DETAILED DESCRIPTION OF THE INVENTION

Hereinafter, an embodiment of the present invention will be described in detail with reference to the drawings.

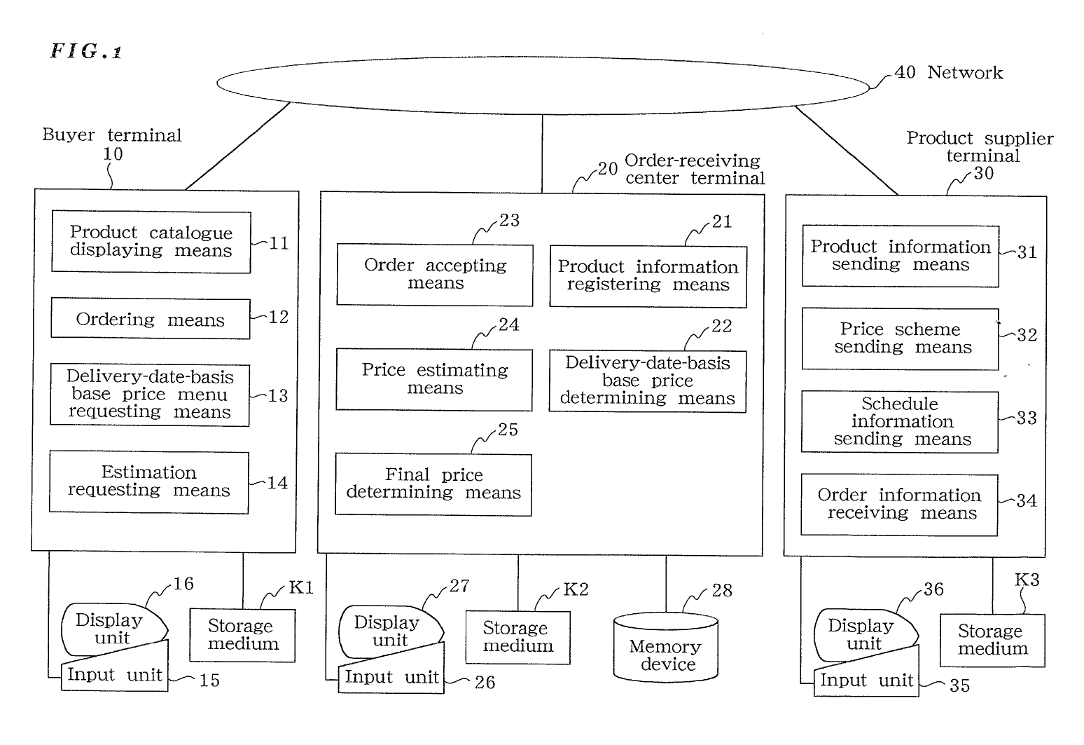

FIG. 1 is a block diagram showing an example of the present invention, which includes a buyer terminal 10, an order-receiving center terminal 20, a product supplier terminal 30 and a network 40 such as the Internet for connecting them.

The product supplier terminal 30 is an information processing device such as a personal computer, which is provided with a product information sending means 31, a price scheme sending means 32, a schedule information sending means 33, an order information receiving means 34, an input unit 35 such as a keyboard, a display unit 36 such as an LCD display and a storage medium K3. Although only a single product supplier terminal 30 is shown in FIG. 1, a plurality of product supplier terminals 30 are connected to the network 40 in practice.

The product information sending means 31 has functions of sending and registering product information of a product sold on the network 40 to and at the order-receiving center terminal 20 via the network 40. The product information includes a specification, a standard selling price and the like of the product. The standard selling price is determined by the product supplier, and the final selling price will not exceed this price.

The price scheme sending means 32 has a function of sending a price scheme to the order-receiving terminal 20 for the product registered at the order-receiving center terminal 20. The price scheme is used for determining the final selling price, delivery-date-basis base prices and an estimated price. In this example, the price scheme includes discount rates based on total order quantities and discount rates based on periods to the delivery dates.

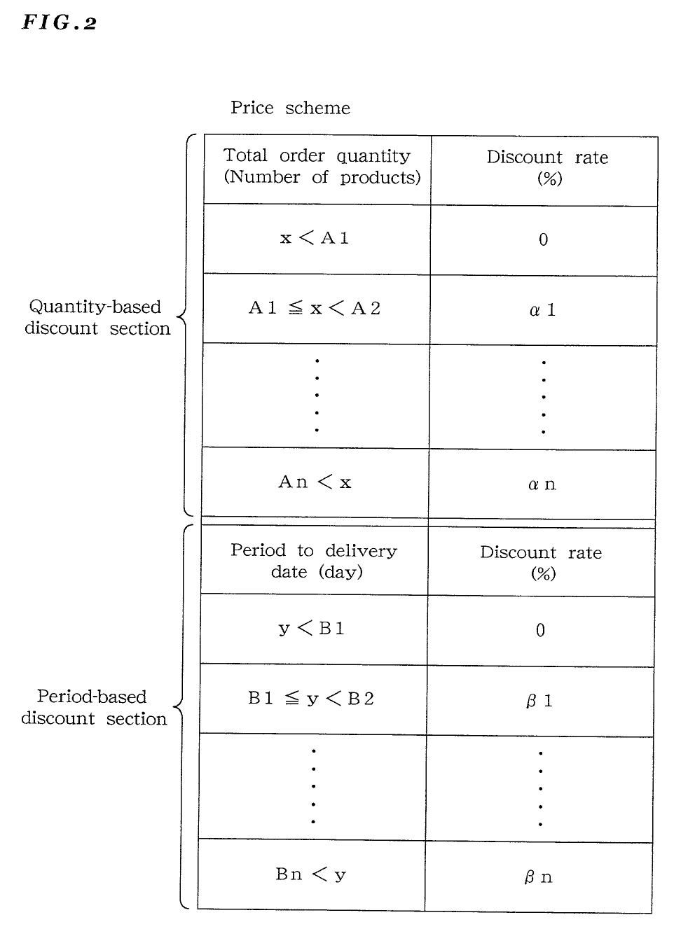

FIG. 2 is a diagram showing an example of the price scheme, including a quantity-based discount section where the discount rates are set based on the total order quantities and a period-based discount section where the discount rates are set based on the periods to the delivery dates. In the case shown in FIG. 2, the discount rate is 0% when the order quantity x is smaller than A1, α1% when x is equal to or larger than A1 but smaller than A2, and αn% when x is larger than An. On the other hand, the discount rate is 0% when the period y to the delivery date is shorter than B1, β1% when y is equal to or longer than B1 but shorter than B2, and βn% when y is longer than Bn. Here, the relationships are A1<A2< . . . <An and B1<B2< . . . <Bn.

The schedule information sending means 33 has a function of sending schedule information to the order-receiving center terminal 20 for the product registered at the order-receiving center terminal 20, including (one or more) delivery dates and a closing date for order acceptance for each delivery date.

The order information receiving means 34 has a function of receiving order information including the final selling price from the order-receiving center terminal 20.

The storage medium K3 is a disk, a semi-conductor memory or the like, which stores a program for realizing the product supplier terminal 30 such as a personal computer as part of the selling price determining system. This program is run on the product supplier terminal 30 to control the operations by the product supplier terminal 30, thereby realizing the product information sending means 31, the price scheme sending means 32, the schedule information sending means 33 and the order information receiving means 34 on the product supplier terminal 30.

The buyer terminal 10 is an information processing device such as a personal computer, which is provided with a product catalogue displaying means 11, an ordering means 12, a delivery-date-basis base price menu requesting means 13, an estimation requesting means 14, an input unit 15 such as a keyboard, a display unit 16 such as an LCD display and a storage medium K1. Although only a single buyer terminal 10 is shown in FIG. 1, a plurality of buyer terminals 10 are connected to the network 40 in practice.

The product catalogue displaying means 11 has functions of acquiring and displaying a product catalogue introducing a plurality of products registered by the product suppliers, from the order-receiving center terminal 20 on a display screen of the display unit 16.

The delivery-date-basis base price menu requesting means 13 has a function of sending a request for a delivery-date-basis base price menu to the order-receiving center terminal 20 together with a product identifier of the product specified by the user, and a function of displaying the delivery-date-basis base price menu sent from the order-receiving center terminal 20 on the display screen of the display unit 16. The delivery-date-basis base price menu is prepared for each product under the control of the order-receiving center terminal 20 and includes base prices of the product for respective delivery dates.

The estimation requesting means 14 has a function of sending a request for an estimation to the order-receiving center terminal 20 together with a desired quantity and a desired delivery date of the product input by the user, and a function of displaying the estimated price sent from the order-receiving center terminal 20 on the display screen of the display unit 16.

The ordering means 12 has a function of notifying the order-receiving center terminal 20, when an order is confirmed by the user via the input unit 15, that the order has been confirmed with the quantity and delivery date sent from the estimation requesting means 14.

The storage medium K1 is a disk, a semi-conductor memory or the like, which stores a program for realizing the buyer terminal 10 such as a personal computer as part of the selling price determining system. This program is run on the buyer terminal 10 to control the operations by the buyer terminal 10, thereby realizing the product catalogue displaying means 11, the ordering means 12, the delivery-date-basis base price menu requesting means 13 and the estimation requesting means 14 on the buyer terminal 10.

The order-receiving center terminal 20 is a server device managed by a product supplier or an independent service contractor, which is provided with a product information registering means 21, a delivery-date-basis base price determining means 22, an order accepting means 23, a price estimating means 24, a final price determining means 25, an input unit 26 such as a keyboard, a display unit 27 such as an LCD display, a memory device 28 and a storage medium K2.

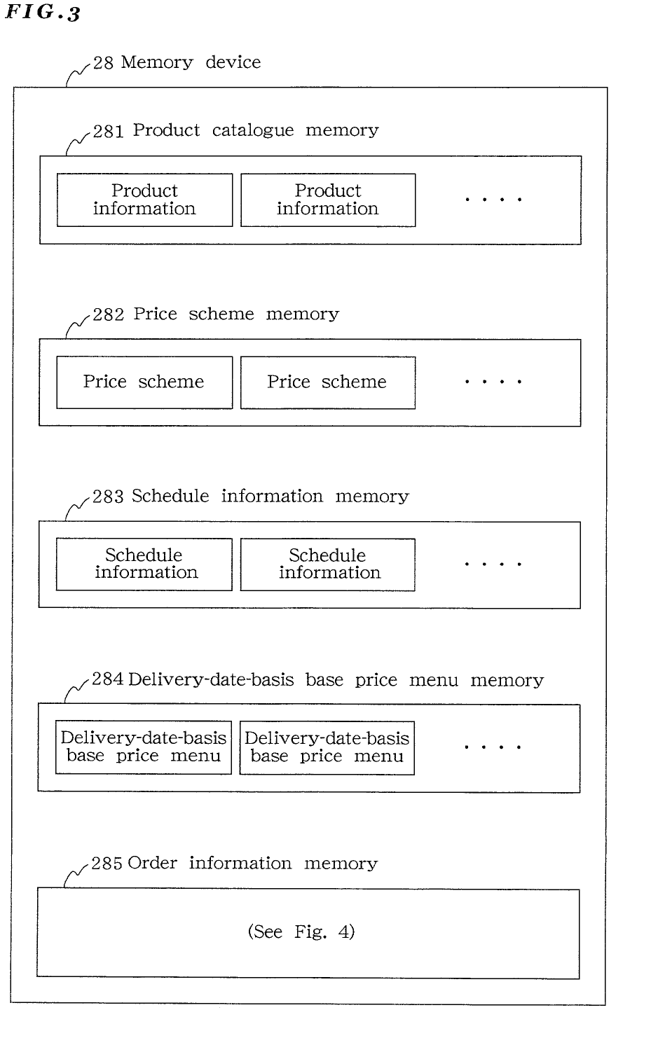

As shown in FIG. 3, the memory device 28 is provided with a product catalogue memory 281, a price scheme memory 282, a schedule information memory 283, a delivery-date-basis base price menu memory 284 and an order information memory 285.

The product information registering means 21 has a function of registering product information, price scheme and schedule information sent from the product supplier terminal 30 in the product catalogue memory 281, the price scheme memory 282 and the schedule information memory 283 of the memory device 28, respectively. The product information, the price scheme and the schedule information for the same product are provided with an identical unique product identifier by the product information registering means 21 so as to tell that they are information of the same product.

The delivery-date-basis base price determining means 22 has the following functions (a) to (d).

(a) Upon a registration of product information, price scheme and delivery date in the memory device 28 by the product information registration means 21, a function of generating a delivery-date-basis base price menu for the product specified by the above information and a function of registering the menu in the delivery-date-basis base price menu memory 284. The generated delivery-date-basis base price menu is provided with the same product identifier as those provided for the above product information and the like.

(b) Upon receiving a request for the delivery-date-basis base price menu from the buyer terminal 10, functions of acquiring and sending the delivery-date-basis base price menu of the product specified by the product identifier sent with the request, from the delivery-date-basis base price menu memory 284 to the buyer terminal 10.

(c) Upon receiving a notice of order confirmation from the buyer terminal 10, a function of resetting the base price for the delivery date of the confirmed order based on the so-far accepted total order quantity and the period from the present time point to the above-mentioned delivery date.

(d) Upon resetting the delivery-date-basis base price menu, a function of resetting the base prices for respective delivery dates based on the periods from the present time point to the respective delivery dates and so-far accepted total order quantities for the respective delivery dates.

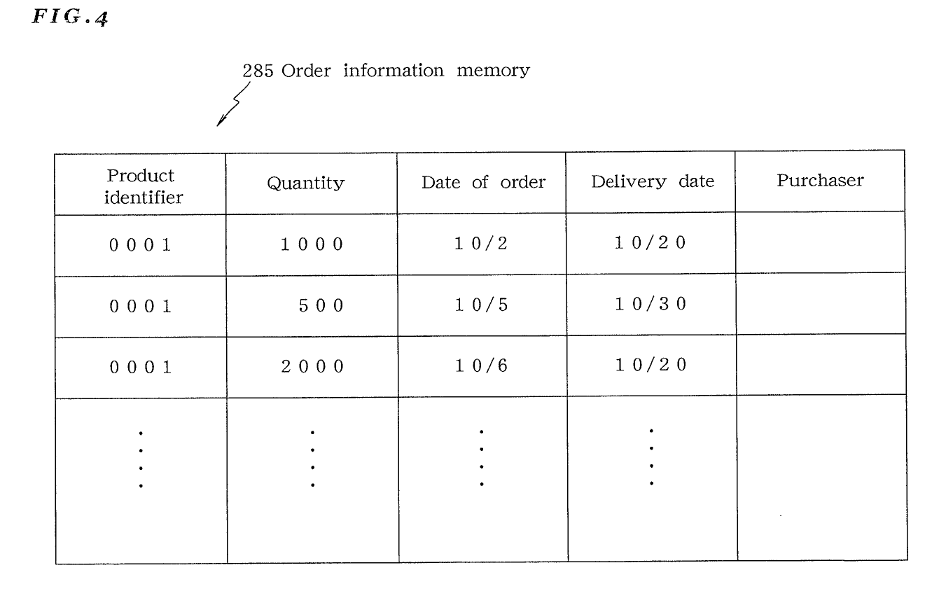

The ordering means 23 has a function of, upon receiving a request from the buyer terminal 10, sending product information (product catalogue) stored in the product catalogue memory 281 to the buyer terminal 10, and a function of registering the information of the confirmed order (i.e., product identifier, order quantity, date of order, delivery date, name of buyer, etc.) in the order information memory 285 once it receives a notice of order confirmation from the buyer terminal 10. FIG. 4 is a diagram showing an example of data stored in the order information memory 285.

The price estimating means 24 has a function of estimating the price upon receiving a request and a function of sending the estimated price to the buyer terminal 10.

The final price determining means 25 has a function of calculating the final selling price for the order confirmed by the buyer terminal 10 based on the standard selling price of the ordered product, the period from the time point of order to the delivery date and the total order quantity for the delivery date that has been accepted by the time order acceptance is closed, accepted until the closing date.

The storage memory K2 is a disk, a semi-conductor memory or the like, which stores a program for realizing the order-receiving center terminal 20, which is a computer, as part of the selling price determining system. This program is run on the order-receiving center terminal 20 to control the operations by the order-receiving center terminal 20, thereby realizing the product information registering means 21, the delivery-date-basis base price determining means 22, the order accepting means 23, the price estimating means 24, and the final price determining means 25 on the order-receiving center terminal 20.

Hereinafter, operations according to this example will be described with reference to the drawings. In the following description, the network 40 refers to the Internet.

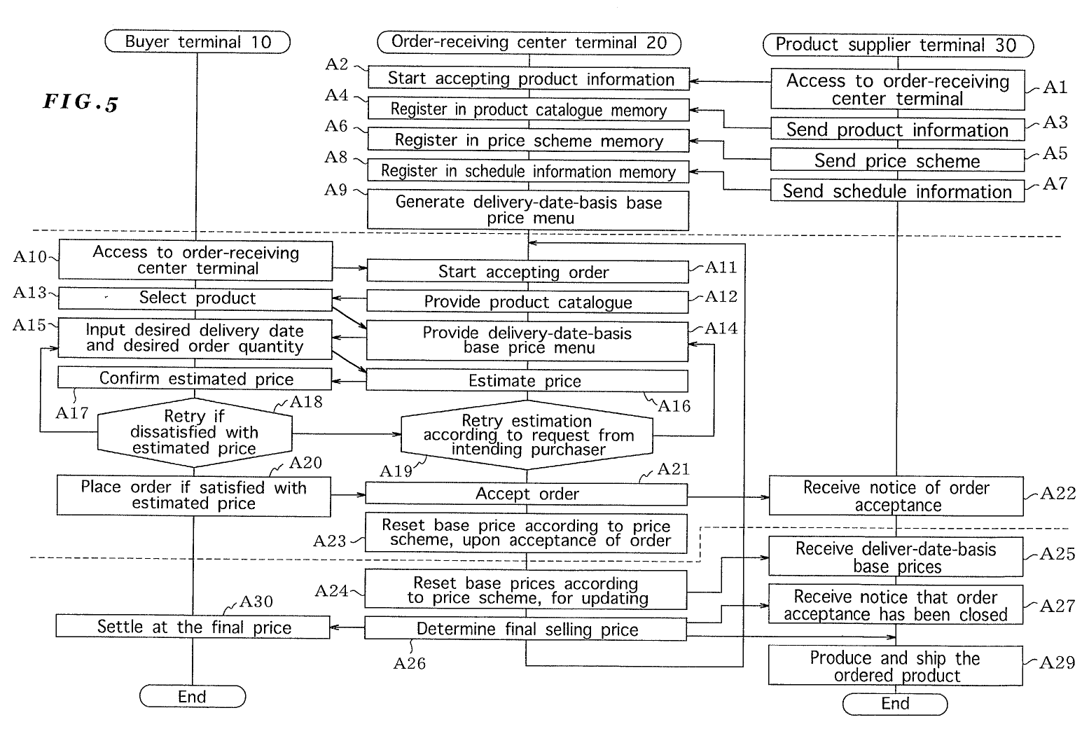

First, an operation for registering product information will be described. Referring to FIG. 5, the product supplier terminal 30 makes access to the order-receiving center terminal 20 via the Internet 40 (Step A1), upon which the order-receiving center terminal 20 shifts to an awaiting made for receiving product information and the like (Step A2). Then, the supplier terminal sends product information, a price scheme and schedule information of the Product A to be sold on the Internet 40 to the order-receiving center terminal 20 by using the product information sending means 31, the price scheme sending means 32 and the schedule information sending means 33, respectively (Steps A3, A5 and A7).

The product information registering means 21 of the order-receiving center terminal 20 registers the product information, the price scheme and the schedule information sent from the product supplier terminal 30 in the product catalogue memory 281, the price scheme memory 282 and the schedule information memory 283, respectively (Steps A4, A6 and A8). The product information registering means 21 adds a unique identical product identifier to each of the above-mentioned information to show that they are information of the same product, and sends the product identifier to the product supplier terminal 30 to inform the product identifier to the supplier.

After registering the product information, the price scheme and the schedule information, the product information registering means 21 gives the information and the associated product identifier to the delivery-date-basis base price determining means 22. Then, the delivery-date-basis base price determining means 22 calculates base prices, while the order quantities for respective delivery dates are set to “0”, based on a standard selling price contained in the product information, discount rates of the period-based discount section contained in the price scheme and the respective delivery dates contained in the schedule information. Based on the obtained base prices, the delivery-date-basis base price determining means 22 generates a delivery-date-basis base price menu for the intending purchaser and stores it in the delivery-date-basis base price menu memory 284 (Step A9). The generated delivery-date-basis base price menu is added with the product identifier given from the product information registering means 21.

The operation in Step A9 will be described in detail. If, for instance, the schedule information contains three delivery dates Y1, Y2 and Y3, the delivery-date-basis base price determining means 22 first obtains periods y1, y2 and y3 from the present time point Y0 to the respective delivery dates Y1, Y2 and Y3. Then, discount rates corresponding to the respective periods y1, y2 and y3 will be acquired from the period-based discount section in the price scheme. Here, the discount rates corresponding to the periods y1, y2 and y3 are, for example, 0%, β1% and β2%, respectively. The base prices k1, k2 and k3 for the respective delivery dates Y1, Y2 and Y3 are determined by the following equations based on the standard selling price H contained in the product information and the discount rates (i.e., 0%, β1% and β2% obtained from the price scheme).

k1=H×(1−0/100) (1)

k2=H×(1−β1/100) (2)

k3=H×(1−β2/100) (3)

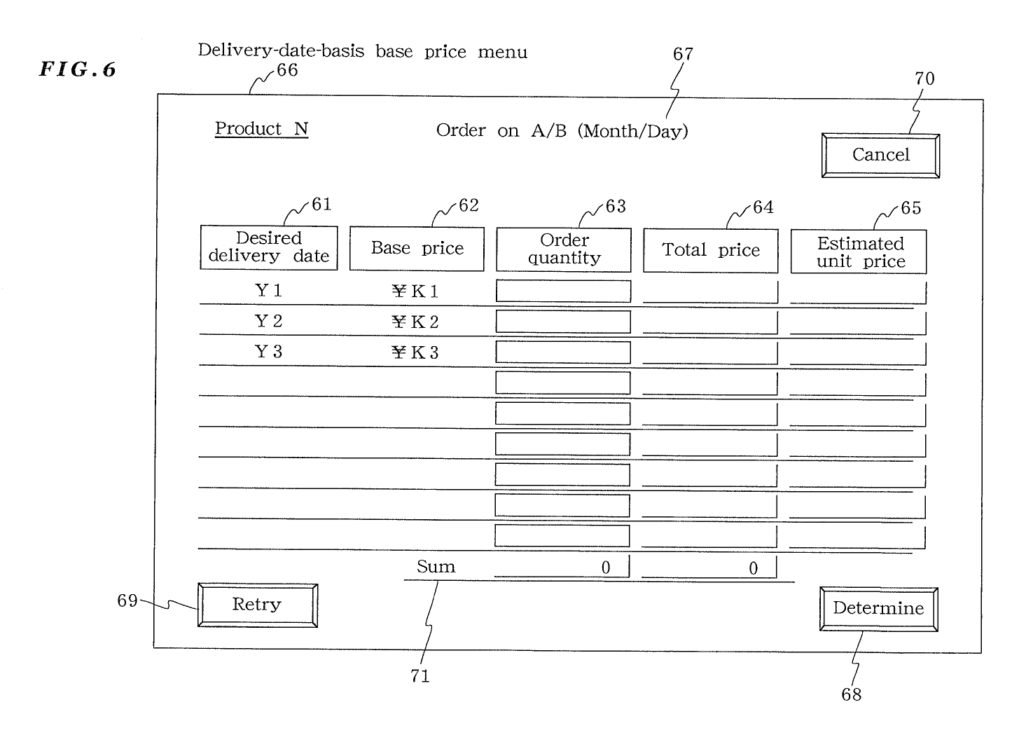

Then, a delivery-date-basis base price menu containing the base prices k1, k2 and k3 for the respective delivery dates Y1, Y2 and Y3 is generated as shown in FIG. 6 and registered in the delivery-date-basis base price menu memory 284. As shown in FIG. 6, the delivery-date-basis base price menu includes, other than a delivery date column 61 and a base price column 62, a column to input an order quantity 63, a total price column 64, an estimated unit price column 65, a product identifier 66, a present date 67, a determine button 68, a retry button 69, a cancel button 70 and a sum column 71. In this manner, the operation in Step A9 is carried out.

Next, the operation for placing an order by the buyer terminal 10 will be described. First, the intending purchaser makes access to the order-receiving center terminal 20 with the buyer terminal 10 via the Internet 40 (Step A10), upon which the order-receiving center terminal 20 shifts to an awaiting mode for accepting product orders, and the order accepting means 23 sends a product catalogue stored in the product catalogue memory 281 to the buyer terminal 10 (Steps A11 and A12).

Upon receiving the product catalogue from the order-receiving center terminal 20, the product catalogue displaying means 11 of the buyer terminal 10 displays the product catalogue on the display unit 16. Once the intending purchaser who has looked through this product catalogue selects a product of interest (e.g., Product A) on the product catalogue, the delivery-date-basis base price menu requesting means 13 sends a request for a delivery-date-basis base price menu to the order receiving center terminal 20 together with the product identifier of Product A (Step A13).

Upon receiving the product identifier of Product A, the order accepting means 23 of the order-receiving center terminal 20 uses this product identifier as a key to search in the delivery-date-basis base price menu memory 284, thereby acquiring the delivery-date-basis base price menu for Product A. The acquired delivery-date-basis base price menu for Product A is then sent to the buyer terminal 10 (Step A14).

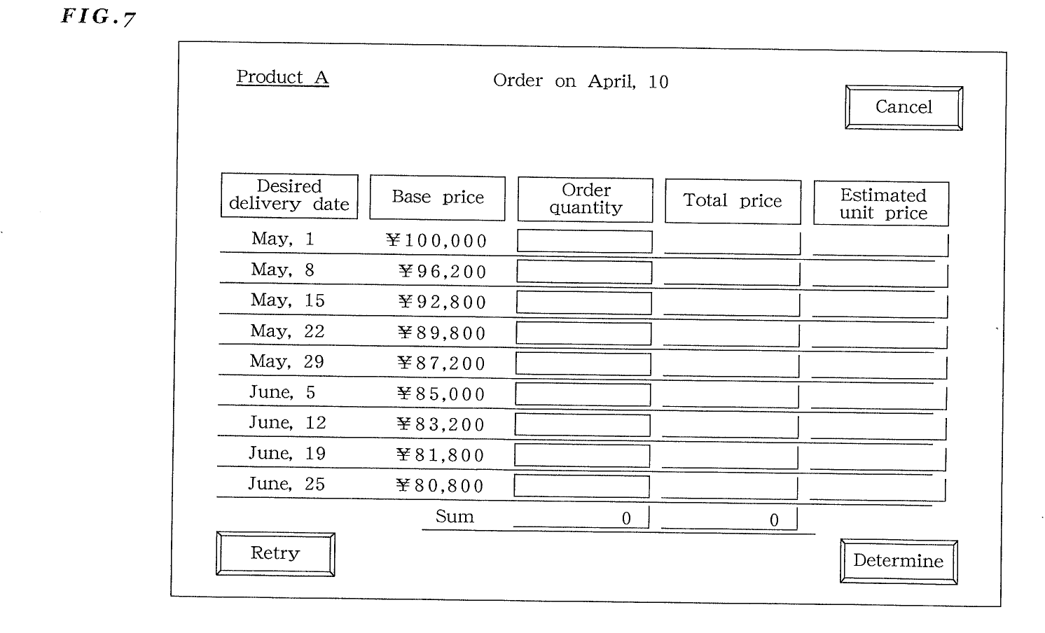

The delivery-date-basis base price menu requesting means 13 of the buyer terminal 10 displays the delivery-date-basis base price menu for Product A as shown in FIG. 7. The intending purchaser inputs quantity of intending purchase (10,000) in a quantity frame corresponding to a desired delivery date (June, 5th). Then, the estimation requesting means 14 sends a request for estimation to the order-receiving center terminal 20 together with the desired product quantity (10,000) and desired delivery date (June, 5th) (Step A15).

The price estimating means 24 of the order-receiving center terminal 20 estimates the selling price based on the desired product quantity and the desired delivery date contained in the estimation request, the so-far accepted total order quantity of Product A for the above delivery date (counting the desired order quantity), the standard selling price of Product A and the price scheme for Product A, and sends the estimated price to the buyer terminal 10 (Step A16).

The operation in Step A16 will be described in detail. First, the period from the present time point to the delivery date (June, 5th) is obtained. Referring to the period-based discount section of the price scheme, the discount rate (in this case, β) corresponding to the period is obtained. Then, the so-far accepted total order quantity of Product A for the above delivery date (June, 5th) is obtained counting the desired order quantity. The total order quantity including the desired order quantity is obtained, for example, as follows. First, order information including the product identifier of Product A and the delivery date, June, 5th, is searched in the order information memory 285. Then, the order quantities contained in the searched order information and the desired order quantity (10,000) are summed, thereby obtaining the total order quantity including the desired order quantity. Referring to the quantity-based discount section of the price scheme, a discount rate (in this case, α) corresponding to the total order quantity including the desired product quantity is obtained. Then, a price is estimated according to the following equation (4).

Estimated price=(Standard selling price of Product A)×(1−/100)×(1−β/100) (4)

In this manner, the operation in Step A16 is carried out.

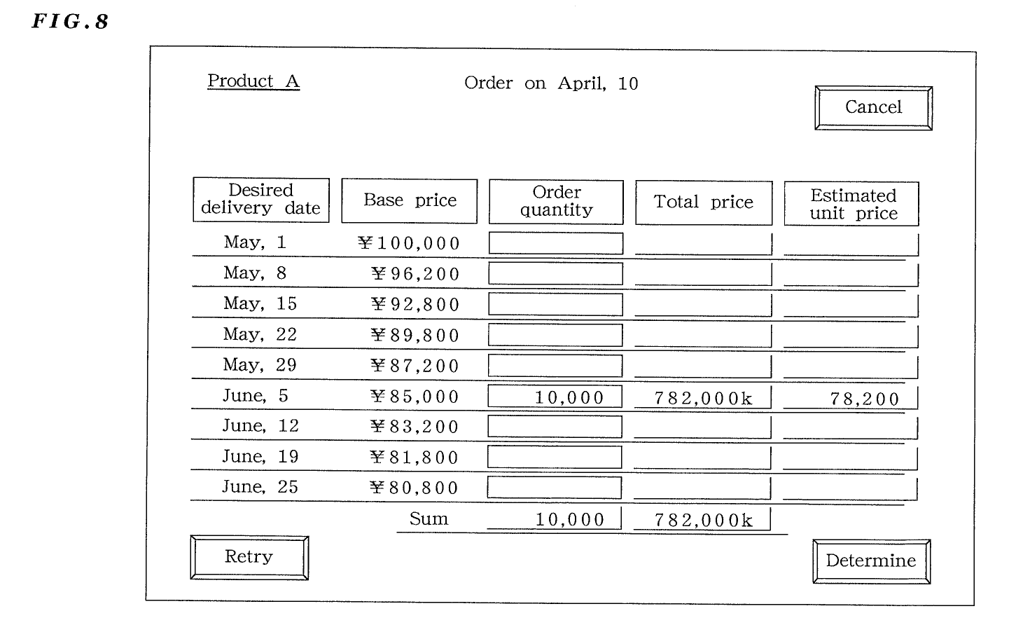

Upon receiving the estimated price from the order-receiving center terminal 20, the estimation requesting means 14 of the buyer terminal 10 displays the estimated price on the estimated unit price column as shown in FIG. 8, and calculates and displays the total price on the total price column (Step A17). The intending purchaser looks at the displayed estimated price. If the estimated price is dissatisfying, the intending purchaser can press the retry button to return to the step of inputting a desired order quantity (Steps A18 and A19). If the estimated price is satisfying, the intending purchaser presses the determine button, whereby the ordering means 12 sends a notice of order confirmation to the order-receiving center terminal 20 (Step A20).

Upon receiving the notice of order confirmation from the buyer terminal 10, the order accepting means 23 of the order-receiving center terminal 20 registers the order information containing data of the confirmed order information in the order information memory 284, and informs the product supplier terminal 30 about the order acceptance (Step A21 and A22). Upon receiving the notice of order confirmation from the buyer terminal 10, the delivery-date-basis base price determining means 22 revises the base price of Product A for the delivery date (June, 5th) in the delivery-date-basis base price menu to the estimated price determined in Step A16 (Step A23).

At the time of update (e.g., a predetermined time on a predetermined day of week), the delivery-date-basis base price determining means 22 updates the delivery-date-basis base price menu for each product and sends the updated delivery-date-basis base price menu to the product supplier terminal (Step A24). The product supplier terminal 30 receives the updated delivery-date-basis base price menu (Step A25).

The operation in Step A24 will be described in detail. Here, one of the delivery-date-basis base price menu registered in the delivery-date-basis base price menu memory 284, the delivery-date-basis base price menu for Product A including three delivery dates Y1, Y2 and Y3, is considered. The delivery-date-basis base price determining means 22 first obtains periods y1, y2 and y3 from the present time point Y0 to the respective delivery dates Y1, Y2 and Y3. Then, discount rates corresponding to the respective periods y1, y2 and y3 are acquired from the period-based discount section in the price scheme for Product A stored in the price scheme memory 282. Here, the discount rates corresponding to the periods y1, y2 and y3 are, for example, 0%, β1% and β2%, respectively. Referring to the order information memory 285, the total order quantities T1, T2 and T3 for Product A for the respective delivery dates Y1, Y2 and Y3 are obtained, and discount rates for the respective total order quantities T1, T2 and T3 are acquired from the quantity-based discount section in the price scheme for Product A. Here, the discount rates corresponding to the total order quantities T1, T2 and T3 are, for example, 0%, β1% and β2%, respectively. The base prices k1, k2 and k3 for the respective delivery dates Y1, Y2 and Y3 are determined by the following equations (5) to (7) based on the standard selling price H of Product A and the discount rates acquired from the price scheme.

K1=H×(1−0/100)×(1−0/100) (5)

K2=H×(1−α1/100)×(1−β1/100) (6)

K3=H×(1−α2/100)×(1−β2/100) (7)

Then, the base prices for the respective delivery dates Y1, Y2 and Y3 existing in the delivery-date-basis base price menu for Product A are altered to the base prices k1, k2 and k3 calculated according to the above equations (5) to (7). Then, the same operation is carried out for the next delivery-date-basis base price menu. The above-described operation is repeated for every delivery-date-basis base price menu. In this manner, the operation in Step 24 is carried out.

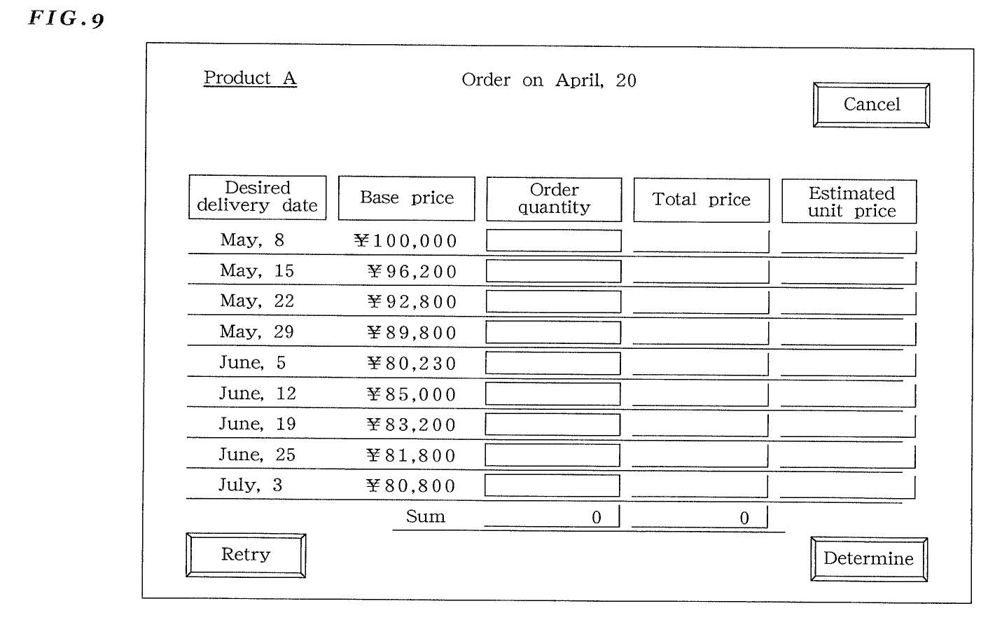

When a new intending purchaser desires to purchase this product for the same delivery date, the altered delivery-date-basis base price is applied. FIG. 9 is an image of a delivery-date-basis base price menu displayed on the buyer terminal 10 after the new purchaser has gone through Steps A10 to A15. The prices for the respective delivery dates have been updated according to the elapsed time, and the price for the above delivery date (June, 5th) that has been ordered reflects the price alteration. Thus, an intending purchaser can compare the prices and the delivery dates to select a desirable delivery date.

At a predetermined timing (e.g., a predetermined time of a day), the final price determining means 25 determines a final selling price for a product whose order has been closed (Step A26).

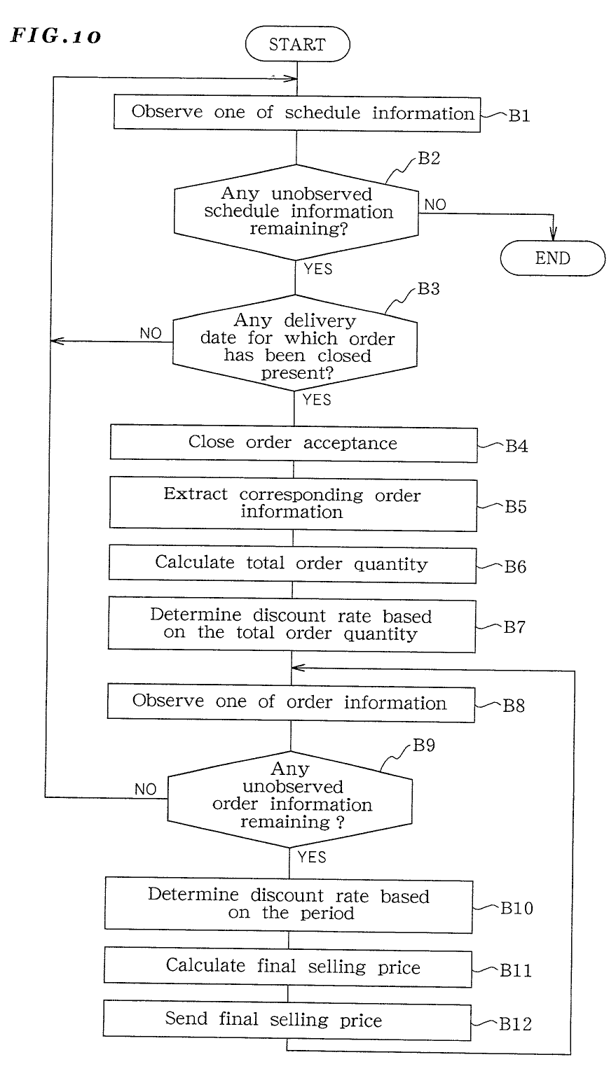

In Step A26, the following operation is carried out. First, one of the schedule information for products registered in the schedule information memory 283, for example, schedule information of Product A, is observed to see if any delivery date information has been expired (FIG. 10, Steps B1 and B3). When there is no delivery date expired, the operation is carried out for the next schedule information. When there is any delivery date expired (e.g., delivery date B), the order acceptance of Product A for that delivery date B is closed and the product supplier terminal is informed that the order acceptance for Product A for that delivery date B has been closed (Step B4). The product supplier terminal 30 receives this notice (Step A27). In Step B4, the expired delivery date and the expiring date for that delivery date are deleted from the schedule information. Information relating to the delivery date B for Product A is also deleted from the delivery-date-basis base price menu.

Thereafter, the whole order information of Product A for the delivery date B is extracted from the order information memory 285 (Step B5). Then, the order quantities in the extracted information are summed to determine the total order quantity (Step B6). Based on the price scheme for Product A, a discount rate (e.g., α) corresponding to the total order quantity is determined (Step B7). Then, one of the extracted order information is observed (Step B8) to calculate a period from the time of order to the delivery date contained in that order information and determine a discount rate (e.g., β) corresponding to this period based on the price scheme (Step B10). Then, the final selling price is calculated according to the following equation (8) (Step B11).

Final selling price=(standard selling price of Product A)×(1−α/100)×(1−β/100) (8)

The extracted order information and the final selling price obtained by the above equation (8) are sent together to the buyer terminal 10 that has made that order as well as to the product supplier terminal 30 (Step B12). The same operation is carried out for the order information following the order information extracted in Step B5 (Step B8). When there is no order information remaining to be observed (i.e., NO in Step B9), the same operation is carried out for one of the other schedule information registered in the schedule information memory 283 (Step B1). The operation is repeated for every schedule information (until the answer in Step B2 becomes NO).

In this manner, the operation in Step N26 is carried out.

The product supplier controlling the product supplier terminal 30 produces and delivers the product in accordance with the order information including the final price sent from the order-receiving center terminal 20 (Step A29). The purchaser controlling the buyer terminal 10 pays according to the order information including the final price sent from the order-receiving center terminal 20.

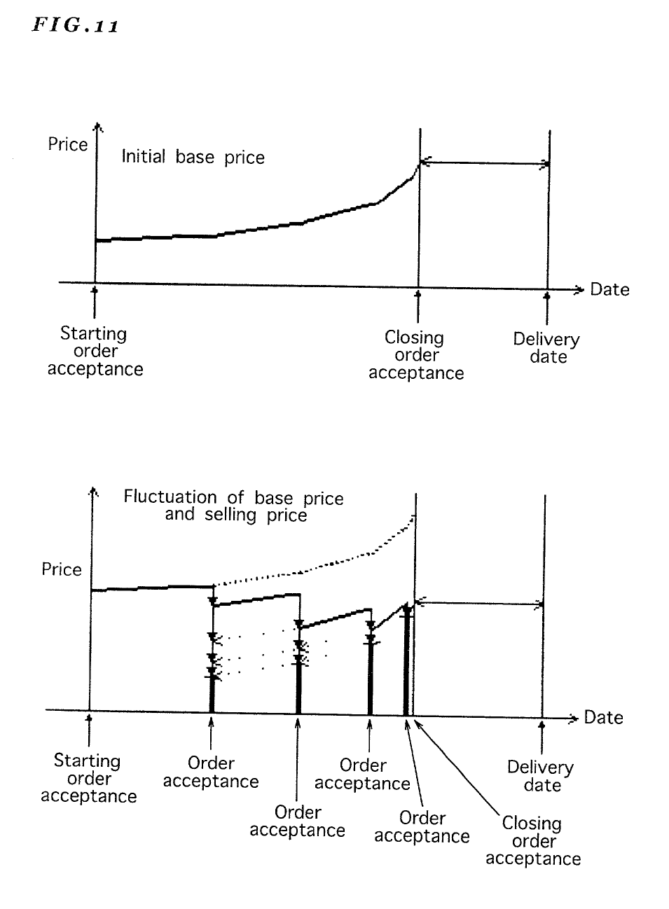

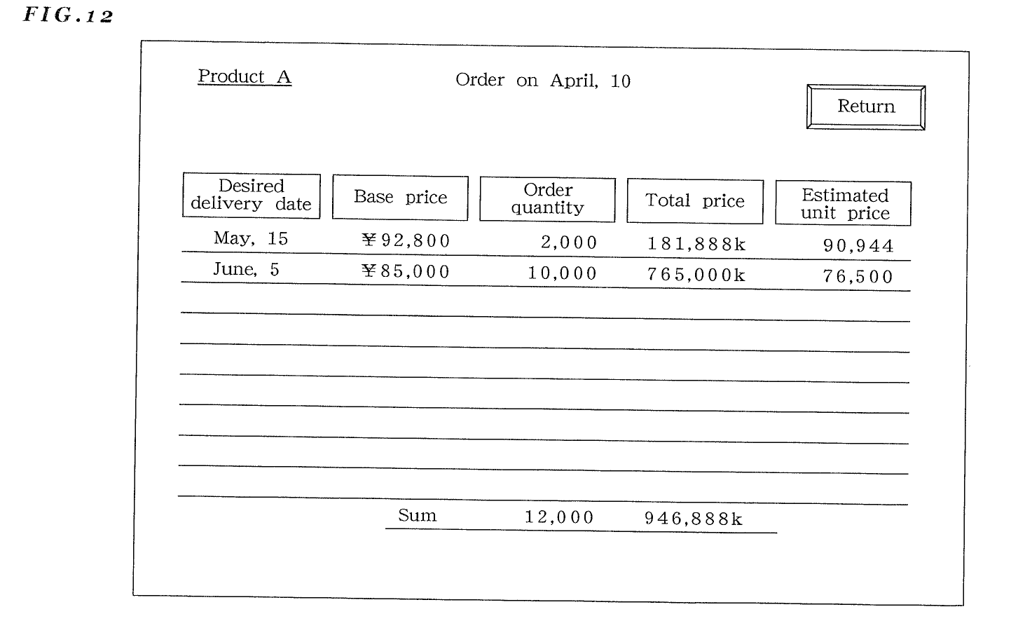

FIG. 11 is a diagram showing the price fluctuation according to the period and quantity of order. The base price with no order becomes higher as the date of order acceptance becomes closer to the delivery date. Whenever an order is placed, the price is reset according to the order quantity and the timing. The reset price is applicable to the already-placed orders. FIG. 12 is an image showing that such a price resetting can be confirmed on a screen. The prices are reduced whenever a new order is made for the corresponding delivery date.

When an order is cancelled later, the price may be raised since the quantity of the ordered products is reduced. However, this can be prevented by setting a penalty that is enough to cover the loss of the other intending purchasers who have ordered the same product for the same delivery date. Thus, no loss is imposed on the other intending purchasers or the product supplier. According to the above-described example, the purchasing quantity for a single delivery date is not particularly limited. However, since there is a limit to the number of products that can actually be provided, the limit quantity may be presented on the delivery-date-basis base price menu in advance. According to the above-described example, the price scheme is not changed through the whole process. However, the price scheme may be altered before a first order is received (until then no loss is caused). Although a penalty is imposed when an order is cancelled, the order may be cancelled without a penalty within a predetermined period or a predetermined quantity. Although there is no means for informing the start of order acceptance to possible purchasers in the above-described example, information including the start of the order acceptance may be distributed in an active manner because faster order results in less expensive price of the product. Although the delivery-date-basis base price on the screen is displayed on day basis, the base price may be set common for a predetermined period.

According to the present invention, the final selling price of a product for a delivery date is calculated based on the standard selling price determined by the product supplier, the period from the ordering date to the delivery date and the total order quantity of the product on the same delivery date. Thus, the selling price of a product can advantageously be determined according to the state of order. This system is also beneficial for the intending purchasers since faster order realizes less expensive purchase. For the product supplier, the production quantity can be confirmed in advance.

Furthermore, according to the present invention, the delivery-date-basis menu including the base prices of the product that the purchaser is intending to purchase for respective delivery dates is sent from the order-receiving center terminal to the buyer terminal, whereby the purchasers can confirm that a price of a product is reduced to more extent for a delivery date with higher order quantity. Thus, mass orders are likely to be placed. The purchaser can expect the price of the desired product to be reduced while the product supplier can expect mass order quantity.

Moreover, according to the present invention, the price scheme is given to the order-receiving center terminal in advance so that price fluctuation can rapidly and dynamically given to the intending purchasers. This allows the intending purchaser to easily determine a purchase based on the selling prices while for the product supplier, there is no need of re-calculating the prices at each timing.

The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-320673 (Filed on Oct. 20, 2000) including specification, claims, drawings and summary are incorporated herein by reference in its entirety.

What is to be claimed:

1. A method for determining a selling price in a network system where a plurality of buyer terminals, an order-receiving center terminal and a plurality of product supplier terminals are connected via a network, wherein:
A) the buyer terminal is operated by a user to place an order by sending a product identifier for specifying a product to be ordered, an order quantity and a delivery date to the order-receiving center terminal;
B) the order-receiving center terminal determines a final selling price of the product ordered by the buyer terminal based on a standard selling price of the ordered product, a period from the time of order to the delivery date and a total order quantity for the same delivery date that has been accepted by the time order acceptance is closed, and sends the determined final selling price to, among the plurality of product supplier terminals, a product supplier providing the ordered product; and
C) the product supplier terminal receives the final selling price sent from the order-receiving center terminal.

2. A method for determining a selling price in a network system where a plurality of buyer terminals, an order-receiving center terminal and a plurality of product supplier terminals are connected via a network, wherein:
A) the buyer terminal is operated by a user to send a request for a delivery-date-basis base price menu for a desired product to the order-receiving center terminal together with a product identifier of the desired product;
B) the order-receiving center terminal sends the delivery-date-basis base price menu to the buyer terminal, which includes base prices corresponding to a plurality of delivery dates for the product specified by the product identifier sent with the request for the delivery-date-basis base price menu;
C) the buyer terminal displays the delivery-date-basis base price menu sent from the order-receiving center terminal on a display device, after which the user places an order by sending an order quantity and a delivery date to the order-receiving center terminal;
D) the order-receiving center terminal
i) determines a final selling price of the product placed an order by the buyer terminal based on a standard selling price of the ordered product, a period from the time of order to the delivery date, and a total order quantity for the same delivery date that has been accepted by the time order acceptance is closed,
ii) sends the determined final selling price to, among the plurality of product supplier terminals, a product supplier providing the ordered product,
iii) resets, upon accepting an order from the buyer terminal, the base price of the product in the delivery-date-basis base price menu for the delivery date specified by the order based on the so-far accepted total order quantity of the product for the same delivery date and a period from the present time point to the delivery date, and
iv) resets, at a predetermined timing, the base prices of the delivery-date-basis base price menu for respective delivery dates based on the so-far accepted total order quantities of the product for the respective delivery dates and periods from the present time point to the respective delivery dates; and
E) the product supplier terminal receives the final selling price sent from the order-receiving center terminal.

3. A method for determining a selling price in a network system where a plurality of buyer terminals, an order-receiving center terminal and a plurality of product supplier terminals are connected via a network, wherein:
A) the buyer terminal is operated by a user to send a request for a delivery-date-basis base price menu for a desired product to the order-receiving center terminal together with a product identifier of the desired product;
B) the order-receiving center terminal sends the delivery-date-basis base price menu to the buyer terminal, which includes base prices corresponding to a plurality of delivery dates for the product specified by the product identifier sent with the request for the delivery-date-basis base price;
C) the buyer terminal displays the delivery-date-basis base price menu sent from the order-receiving center terminal on a display device, after which the user sends an estimation request to the order-receiving center terminal together with a desired order quantity and a desired delivery date;
D) the order-receiving center terminal
i) estimates a price, upon receiving the estimation request from the buyer terminal, based on a standard selling price of the product to be estimated, a so-far accepted total order quantity of the product to be estimated for the desired delivery date counting the order quantity sent with the estimation request and a period from the present time point to the delivery date, and
ii) sends the estimated price to the buyer terminal;
E) the buyer terminal displays the estimated price sent from the order-receiving center terminal on a display device, after which an order confirmation is sent to the order-receiving center terminal as operated by the user;
F) the order-receiving center terminal
i) determines a final selling price of the product whose order has been confirmed by the buyer terminal based on the standard selling price of the ordered product, a period from the time of order to the delivery date and a total order quantity of the ordered product for the ordered delivery date that has been accepted by the time order acceptance is closed,
ii) sends the determined final selling price to, among the plurality of product suppliers, a product supplier providing the ordered product,
iii) resets, upon receiving the order confirmation from the buyer terminal, the base price of the ordered product in the delivery-date-basis base price menu for the ordered delivery date based on the so-far accepted total order quantity of the product for the same delivery date and a period from the present time point to the delivery date, and
iv) resets, at a predetermined timing, the base prices of the delivery-date-basis base price menu for respective delivery dates based on the so-far accepted total order quantities for the respective delivery dates and periods from the present time point to the respective delivery dates; and
G) the product supplier terminal receives the final selling price sent from the order-receiving center terminal.

4. A method for determining a selling price according to claim 1, wherein the order-receiving center terminal determines the final selling price for the order such that the selling price is less expensive for a larger total order quantity and for a longer period from the time of order to the delivery date.

5. A method for determining a selling price according to claim 4, wherein:
A) the product supplier terminal sends product information to the order-receiving center terminal, which includes the standard selling price of the product to be sold, a price scheme including discount rates based on total order quantities and discount rates based on periods to delivery dates, and schedule information including delivery dates and dates for closing order acceptance for the product; and
B) the order-receiving center terminal determines a selling price for the order based on a total order quantity, a period from the time of order t6 the delivery date and the price scheme.

6. A method for determining a selling price according to claim 2, wherein
A) the order-receiving center terminal:
i) determines the final selling price for the order such that the selling price is less expensive for a larger total order quantity and for a longer period from the time of order to the delivery date; and
ii) resets the base prices in the delivery-date-basis base price menu such that the reset selling prices are less expensive for a larger total order quantity and for a longer period from the time of order to the delivery date.

7. A method for determining a selling price according to claim 6, wherein:
A) the product supplier terminal sends product information to the order-receiving center terminal, which includes the standard selling price of the product to be sold, a price scheme including discount rates based on total order quantities and discount rates based on periods to delivery dates, and schedule information including a plurality of delivery dates and dates for closing order acceptance of the product for the plurality of delivery dates; and
B) the order-receiving center terminal
i) determines the final selling price for the order based on a total order quantity, a period from the time of order to the delivery date and the price scheme, and
ii) resets the base prices in the delivery-date-basis base price menu based on total order quantities, periods from the time of order to the delivery dates and the price scheme.

8. A method for determining a selling price according to claim 3, wherein
A) the order-receiving center terminal:
i) determines the final selling price for the order such that the selling price is less expensive for a larger total order quantity and for a longer period from the time of order to the delivery date;
ii) resets the base prices in the delivery-date-basis base price menu such that the reset selling prices are less expensive for a larger total order quantity and for a longer period from the time of order to the delivery date; and
iii) estimates the price such that the selling price is less expensive for a larger total order quantity and for a longer period from the time of order to the delivery date.

9. A method for determining a selling price according to claim 8, wherein:
A) the product supplier terminal sends product information to the order-receiving center terminal, which includes the standard selling price of the product to be sold, a price scheme including discount rates based on total order quantities and discount rates based on periods to delivery dates, and schedule information including a plurality of delivery dates and dates for closing order acceptance for the product for the respective delivery dates; and
B) the order-receiving center terminal determines:
i) the final selling price for the order based on a total order quantity, a period from the time of order to the delivery date and the price scheme,
ii) resets the base prices in the delivery-date-basis base price menu based on total order quantities, periods from the time of order to the delivery dates and the price scheme, and
iii) estimates the price based on a total order quantity, a period from the time of order to the delivery date and the price scheme.

10. A system for determining a selling price in a network system where a plurality of buyer terminals, an order-receiving center terminal and a plurality of product supplier terminals are connected via a network, wherein:
A) the buyer terminal comprises an ordering means for placing an order as operated by a user by sending a product identifier, an order quantity and a delivery date to the order-receiving center terminal;
B) the order-receiving center terminal comprises a final price determining means for
i) determining a final selling price of the product ordered by the buyer terminal based on a standard selling price of the ordered product, a period from the time of order to the delivery date and a total order quantity for the delivery date that has been accepted by the time order acceptance is closed, and
ii) sending the determined final selling price to, among the plurality of product supplier terminals, a product supplier providing the ordered product; and
C) the product supplier terminal comprises an order information receiving means for receiving the final selling price sent from the order-receiving center terminal.

11. A system for determining a selling price in a network system where a plurality of buyer terminals, an order-receiving center terminal and a plurality of product supplier terminals are connected via a network, wherein,
A) the buyer terminal comprises:
a) a delivery-date-basis base price menu requesting means for
i) sending, as operated by a user, a request for a delivery-date-basis base price menu for a desired product to the order-receiving center terminal together with a product identifier of the desired product, and
ii) displaying the delivery-date-basis base price menu sent from the order-receiving terminal on a display device; and
b) an ordering means for placing an order, as operated by the user, by sending a desired order quantity and a desired delivery date to the order-receiving center terminal,
B) the order-receiving center terminal comprises:
a) a delivery-date-basis base price determining means for
i) sending, upon receiving the request for the delivery-date-basis base price menu, the delivery-date-basis base price menu to the buyer terminal, which includes base prices for a plurality of delivery dates for the product specified by the product identifier sent with the request for the delivery-date-basis base price,
ii) resetting, upon accepting an order from the buyer terminal, the base price of the product in the delivery-date-basis base price menu for the delivery date specified by the order based on the so-far accepted total order quantity of the product for the same delivery date and a period from the present time point to the delivery date, and
iii) resetting, at a predetermined timing, the base prices of the delivery-date-basis base price menu for respective delivery dates based on the so-far accepted total order quantities of the product for the respective delivery dates and periods from the present time point to the respective delivery dates; and
b) a final price determining means for
i) determining a final selling price of the product ordered by the buyer terminal based on a standard selling price of the ordered product, a period from the time of order to the delivery date, and a total order quantity for the same delivery date that has been accepted by the time order acceptance is closed, and
ii) sending the determined final selling price to, among the plurality of product supplier terminals, a product supplier providing the ordered product; and
C) the product supplier terminal comprises an order information receiving means for receiving the final selling price sent from the order-receiving center terminal.

12. A system for determining a selling price in a network system where a plurality of buyer terminals, an order-receiving center terminal and a plurality of product supplier terminals are connected via a network, wherein,
A) the buyer terminal comprises:
a) a delivery-date-basis base price menu requesting means for
i) sending, as operated by a user, a request for a delivery-date-basis base price menu for a desired product to the order-receiving center terminal together with a product identifier of the desired product, and
ii) displaying the delivery-date-basis base price menu sent from the order-receiving center terminal on a display device;
b) an estimation requesting means for
i) sending a request for estimation to the order-receiving center terminal together with an order quantity and a delivery date for the product, and
ii) displaying an estimated price sent from the order-receiving terminal on the display device; and
c) an ordering means for informing the order-receiving center terminal that the order is confirmed with the order quantity and the delivery date sent by the estimation requesting means; and
B) the order-receiving center terminal comprises:
a) a delivery-date-basis base price determining means for
i) sending, upon receiving the request for the delivery-date-basis base price menu from the buyer terminal, the delivery-date-basis base price menu to the buyer terminal, which includes base prices corresponding to a plurality of delivery dates for the product specified by the product identifier sent with the request for the delivery-date-basis base price,
ii) resetting, upon accepting an order confirmation from the buyer terminal, the base price of the product in the delivery-date-basis base price menu for the delivery date specified by the order based on the so-far accepted total order quantity of the product for the delivery date and a period from the present time point to the delivery date, and
iii) resetting, upon a predetermined timing, the base prices of the delivery-date-basis base price menu for respective delivery dates based on periods from the present time point to the respective delivery dates and so-far accepted total order quantities of the product for the respective delivery dates;
b) a price estimating means for
i) estimating a price, upon receiving a request for estimation from the buyer terminal, based on a standard selling price of the product to be estimated, a so-far accepted total order quantity of the product for the delivery date counting the order quantity sent with the estimation request and a period from the present time point to the delivery date, and
ii) sending the estimated price to the buyer terminal; and
c) a final price determining means for
i) determining a final selling price for the confirmed order based on the standard selling price of the ordered product, a period from the time of order to the delivery date, a total order quantity for the same delivery date that has been accepted by the time order acceptance is closed, and
ii) sending the determined final selling price to, among the plurality of product supplier terminals, a product supplier providing the ordered product; and
C) the product supplier terminal comprises an order information receiving means for receiving the final selling price sent from the order-receiving center terminal.

13. A system for determining a selling price according to claim 10, wherein the final price determining means determines a final selling price for the order such that the selling price is less expensive for a larger total order quantity and for a longer period from the time of order to the delivery date.

14. A system for determining a selling price according to claim 13, wherein,
A) the product supplier terminal comprises:
a) a product information sending means for sending product information to the order-receiving center terminal, which includes the standard selling price of the product to be sold;
b) a price scheme sending means for sending a price scheme for the product specified in the product information to the order-receiving center terminal, which includes discount rates based on total order quantities and discount rates based on periods to delivery dates; and
c) a schedule information sending means for sending schedule information to the order-receiving center terminal, which includes delivery dates and closing dates for order acceptance for the product specified in the product information,
wherein the final selling price determining means determines the final selling price for the order based on the total order quantity, the period from the time of order to the delivery date and the price scheme.

15. A system for determining a selling price according to claim 11, wherein:
the final selling price determining means determines the final selling price for the order such that the selling price is less expensive for a larger total order quantity and for a longer period from the time of order to the delivery date; and
the delivery-date-basis base price determining means resets the base prices in the delivery-date-basis base price menu such that the reset selling prices are less expensive for a larger total order quantity and for a longer period from the time of order to the delivery date.

16. A system for determining a selling price according to claim 15, wherein,
A) the product supplier terminal comprises:
a) a product information sending means for sending product information to the order-receiving center terminal, which includes the standard selling price of the product to be sold;
b) a price scheme sending means for sending a price scheme for the product specified in the product information to the order-receiving center terminal, which includes discount rates based on total order quantities and discount rates based on periods to delivery dates; and
c) a schedule information sending means for sending schedule information to the order-receiving center terminal, which includes delivery dates and closing dates for order acceptance for the product specified in the product information,
wherein the final selling price determining means determines the final selling price for the order based on the total order quantity, the period from the time of order to the delivery date and the price scheme, and
wherein the delivery-date-basis base price determining means resets the base prices in the delivery-date-basis base price menu based on a total order quantity, a period from the present time point to the delivery date and the price scheme.

17. A system for determining a selling price according to claim 12, wherein:
the final selling price determining means determines the final selling price for the order such that the selling price is less expensive for a larger total order quantity and for a longer period from the time of order to the delivery date;
the delivery-date-basis base price determining means resets the base prices in the delivery-date-basis base price menu such that the reset selling prices are less expensive for a larger total order quantity and for a longer period from the present time point to the delivery date; and
the price estimating means estimates a price such that the estimated selling price is less expensive for a larger total order quantity and for a longer period from the time of order to the delivery date.

18. A system for determining a selling price according to claim 17, wherein,
A) the product supplier terminal comprises:
a) a product information sending means for sending product information to the order-receiving center terminal, which includes a standard selling price of a product to be sold;
b) a price scheme sending means for sending a price scheme for the product specified in the product information to the order-receiving center terminal, which includes discount rates based on total order quantities and discount rates based on periods to delivery dates; and
c) a schedule information sending means for sending schedule information to the order-receiving center terminal, which includes delivery dates and closing dates of order acceptance for the product specified in the product information,
wherein the final selling price determining means determines the final selling price for the order based on a total order quantity, a period from the time of order to the delivery date and the price scheme,
wherein the delivery-date-basis base price determining means resets the base prices in the delivery-date-basis base price menu based on a total order quantity, a period from the present time point to the delivery date and the price scheme, and
wherein the price estimating means estimates a price based on a total order quantity, a period from the present time point to the delivery date and the price scheme.

19. A computer-readable storage medium for storing a program for realizing a system for determining a selling price in a network system where a plurality of buyer terminal computers, an order-receiving center terminal computer and a plurality of product supplier terminal computers are connected via a network, wherein the program uses:
A) the buyer terminal computer as an ordering means for placing an order, as operated by a user, by sending a product identifier for specifying a product to be ordered, an order quantity and a delivery date to the order-receiving center terminal computer;
B) the order-receiving center terminal computer as a final price determining means for
i) determining a final selling price of the product ordered by the buyer terminal computer based on a standard selling price of the ordered product, a period from the time of order to the delivery date and a total order quantity for the same delivery date that has been accepted by the time order acceptance is closed, and
ii) sending the determined final selling price to, among the plurality of product supplier terminal computers, the product supplier terminal computer providing the ordered product; and
C) the product supplier terminal computer as an order information receiving means for receiving the final selling price sent from the order-receiving center terminal computer.

20. A computer-readable storage medium for storing a program for realizing a system for determining a selling price in a network system where a plurality of buyer terminal computers, an order-receiving center terminal computer and a plurality of product supplier terminal computers are connected via a network, wherein the program uses:
A) the buyer terminal computer as:
a) a delivery-date-basis base price menu requesting means for
i) sending, as operated by a user, a request for a delivery-date-basis base price menu to the order-receiving center terminal computer together with a product identifier of a desired product, and
ii) displaying the delivery-date-basis base price menu sent from the order-receiving terminal computer on a display device, and
b) an ordering means for placing an order, as operated by the user, by sending a desired order quantity and a desired delivery date to the order-receiving center terminal computer;
C) the order-receiving center terminal computer as:
a) a delivery-date-basis base price determining means for
i) sending, upon receiving the request for the delivery-date-basis base price menu, the delivery-date-basis base price menu to the buyer terminal computer, which includes base prices for a plurality of delivery dates for the product specified by the product identifier sent with the request for the delivery-date-basis base price menu,
ii) resetting, upon accepting an order from the buyer terminal computer, the base price of the product in the delivery-date-basis base price menu for the delivery date specified by the order based on the so-far accepted total order quantity of the product for the delivery date and a period from the present time point to the delivery date, and
iii) resetting, upon a predetermined timing, the base prices of the delivery-date-basis base price menu for respective delivery dates based on periods from the present time point to the respective delivery dates and so-far accepted total order quantities of the product for the respective delivery dates; and
b) a final price determining means for
i) determining a final selling price of the product ordered by the buyer terminal computer based on a standard selling price of the ordered product, a period from the time of order to the delivery date and a total order quantity for the same delivery date that has been accepted by the time order acceptance is closed, and
ii) sending the determined final selling price to, among the plurality of product supplier terminal computers, a product supplier terminal computer providing the ordered product; and
D) the product supplier terminal computer as an order information receiving means for receiving the final selling price sent from the order-receiving center terminal computer.

21. A computer-readable storage medium for storing a program for realizing a system for determining a selling price in a network system where a plurality of buyer terminal computers, an order-receiving center terminal computer and a plurality of product supplier terminal computers are connected via a network, wherein the program uses:
A) the buyer terminal computer as:
a) a delivery-date-basis base price menu requesting means for
i) sending, as operated by a user, a request for a delivery-date-basis base price menu to the order-receiving center terminal computer together with a product identifier of a desired product, and
ii) displaying the delivery-date-basis base price menu sent from the order-receiving terminal computer on a display device;
b) an estimation requesting means for sending a request for estimation to the order-receiving center terminal computer together with an order quantity and a delivery date of the product and for displaying an estimated price sent from the order-receiving terminal computer on the display device; and
c) an ordering means for informing the order-receiving center terminal computer, as operated by the user, that the order is confirmed with the order quantity and the delivery date sent from the estimation requesting means;
B) the order-receiving center terminal computer as:
a) a delivery-date-basis base price determining means for
i) sending, upon receiving the request for the delivery-date-basis base price menu from the buyer terminal computer, the delivery-date-basis base price menu to the buyer terminal computer, which includes base prices for a plurality of delivery dates for the product specified by the product identifier sent with the request for the delivery-date-basis base price menu,
ii) resetting, upon receiving an order confirmation from the buyer terminal, the base price of the product in the delivery-date-basis base price menu for the delivery date specified by the order based on the so-far accepted total order quantity of the product for the delivery date and a period from the present time point to the delivery date, and
iii) resetting, upon a predetermined timing, the base prices in the delivery-date-basis base price menu for respective delivery dates based on the so-far accepted total order quantities of the product for the respective delivery dates and periods from the present time point to the respective delivery dates;
b) a price estimating means for
i) estimating a price, upon receiving the request from the buyer terminal computer, based on a standard selling price of the product to be estimated, a so-far accepted total order quantity of the product for the delivery date counting the order quantity sent with the estimation request and a period from the present time point to the delivery date, and
ii) sending the estimated price to the buyer terminal computer; and
c) a final price determining means for
i) determining a final selling price for the order confirmed by the buyer terminal computer based on a standard selling price of the ordered product determined by the supplier of the product, a period from the time of order to the delivery date and a total order quantity for the same delivery date that has been accepted by the time order acceptance is closed, and
ii) sending the determined final selling price to, among the plurality of the product supplier terminal computers, the product supplier terminal computer providing the ordered product; and
C) the product supplier terminal computer as an order information receiving means for receiving the final selling price sent from the order-receiving center terminal computer.
